(19) United States
(12) Patent Application Publication
(10) Pub. No.: US 2001/0000441 A1
(43) Pub. Date: Apr. 26, 2001

(54) Virtual real-time facsimile transmission over the internet

(76) Inventors: Ivo Zinkov, Toronto (CA); Garrison G. Zong, Houston, TX (US); Mike Min-Chu Chen, Sugar Land, TX (US)

Correspondence Address: Darcel Walker, 8107 Carvel Lane, Houston, TX, 77036, US

(21) Appl. No.: 09/729,678

(22) Filed: Dec. 4, 2000

Related U.S. Application Data
(63) Continuation-in-part of application No. 09/289,756, filed on Apr. 12, 1999.
(60) Provisional application No. 60/168,510, filed on Dec. 2, 1999.

(51) Int. Cl. G06F 15/00; G06F 15/16

(52) U.S. Cl. 358/1.15; 358/; 358/1.2; 358/402; 709/206

(57) ABSTRACT

The present invention provides a method for sending faxes over the Internet, in which the sender gets a confirmation immediately after sending the facsimile message over a regular, uncontrolled Internet connection, and using standard modems or a Local Area Network (LAN) connection to the Internet.

### CROSS REFERENCE TO RELATED APPLICATION

1. This application is a continuation-in-part of and claims priority of from application Ser. No. 09/289,756, filed on Apr. 12, 1999, the contents of which are incorporated by reference. This application also claims priority of Provisional application No. 60/168,510 filed Dec. 2, 1999, the contents of which are also incorporated herein by reference.

### FIELD OF THE INVENTION

2. This invention relates to the transmission of information over global computer network such as the Internet, and in particular to a method and system of sending information the Internet in real-time from a facsimile machine.

### BACKGROUND OF THE INVENTION

3. Global computer networks such as the “Internet” have become a major and vital means of communication (Inventor will use the terms “global compute network” and “Internet” interchangeably through this entire discussion). The Internet today can facilitate the transmission of most forms of information including video, audio and text information. In addition, many different end devices can send and receive information over this network. These devices include telephones, facsimile machines and all types of computers. Although many devices can use the Internet to send and receive information, some of these devices that are non-computer devices require a means to connect them to the Internet. One such machine that falls into this category is the facsimile machine.

4. One such device that can connect a facsimile machine to a global computer network is the Internet Fax Box (IFB) described in U.S. patent application Ser. No. 09/289,756, which is incorporated herein by reference. With this device, it is not necessary to use a conventional computer in the communication stream in order to transmit information from a facsimile machine over the Internet. When the IFB is connected to a conventional fax machine, it creates a faxing system that can send and receive facsimile messages over the Internet. One can send faxes to any fax machine within an Internet free fax coverage network, to any standard e-mail based fax network, to other Internet Fax Box (IFBs) anywhere in the world, and can communicate directly with any other computer having an Internet connection.

5. The advantage of sending facsimile messages over the Internet, as opposed to over standard PSTN lines should be obvious—the sender saves the long distance charges, which may exist between the sending and receiving facsimile machines. Most current Internet facsimile applications are related to electronic mail, that is the facsimile image is converted into an e-mail message, and then the e-mailed to the destination fax server over the Internet. The e-mail is converted back to a fax image and printed to the facsimile machine. This method is relatively inexpensive to implement, but the drawback is that the sender is not immediately aware of the success or failure of the transmission. If, for some reason, the facsimile message failed to be delivered to the destination fax machine, the sender can only find out later, by means of a notification sent back to the sender from the remote fax server.

6. Another method of sending faxes over the Internet is real-time transmission. The sending and receiving fax machines negotiate and transmit the facsimile image over the Internet, in real-time, as if they were communicating over a regular PSTN line. Unfortunately, this method is difficult and expensive to implement, due to inherent latency in the rounding of TCP/IP packets over the Internet. The standards to which regular fax machines were designed do not allow for such delays. If this condition is not controlled, the transmission will fail. There remains a need for a method and system of transmitting facsimile messages over the Internet in real time.

### SUMMARY OF THE INVENTION

7. It is an objective of this invention to provide a method that will enable a facsimile machine to transmit a message over the Internet in real-time.

8. It is another object of the present invention to provide a method that will enable a facsimile machine to send messages point-to-point over the Internet in real-time.

9. The present invention provides a method for sending faxes over the Internet, in which the sender gets a confirmation immediately after sending the facsimile message over a regular, uncontrolled Internet connection, and using standard modems or a Local Area Network (LAN) connection to the Internet.

10. In operation the present invention works in conjunction with the Internet Facsimile Box (IFB) described in U.S. patent application Ser. No. 09/289,756. The steps to this operation are as follows: 1) The fax image is read into the sending IFB; 2) the sending IFB connects to the receiving IFB by contacting its fully qualified host name; 3) The facsimile image is transmitted to the receiving IFB; 4) The image is printed to the fax machine connected to the remote IFB; 5) A status message is sent to the sending IFB, which is displayed on the LCD of the sending IFB. The sender is aware of the status of the sent facsimile message at that time. The method of the present invention eliminates the stringent real-time requirements imposed by timing constraints of regular fax machines. The method allows the sender to get immediate acknowledge from the receiving fax machine, without the extra expenses of a true real-time faxing operation.

### DESCRIPTION OF THE DRAWINGS

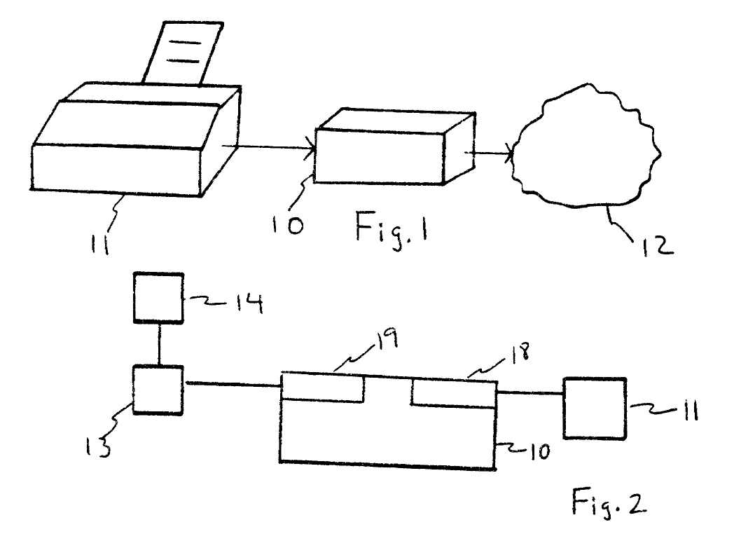

11. FIG. 1 is a configuration of a global computer network facsimile system incorporating the current Internet faxing box (IFB) device.

12. FIG. 2 is a configuration of the access of a fax machine to a global computer network using an Internet faxing box (IFB).

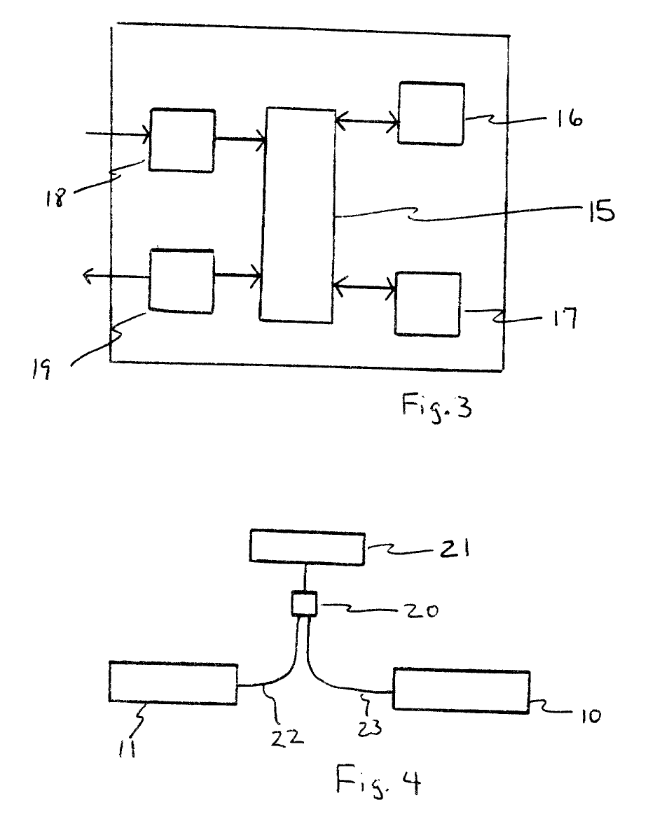

13. FIG. 3 is a hardware block diagram of the Internet faxing box.

14. FIG. 4 is a configuration of the connection of a fax machine to the Internet faxing box via a line voltage simulator adapter.

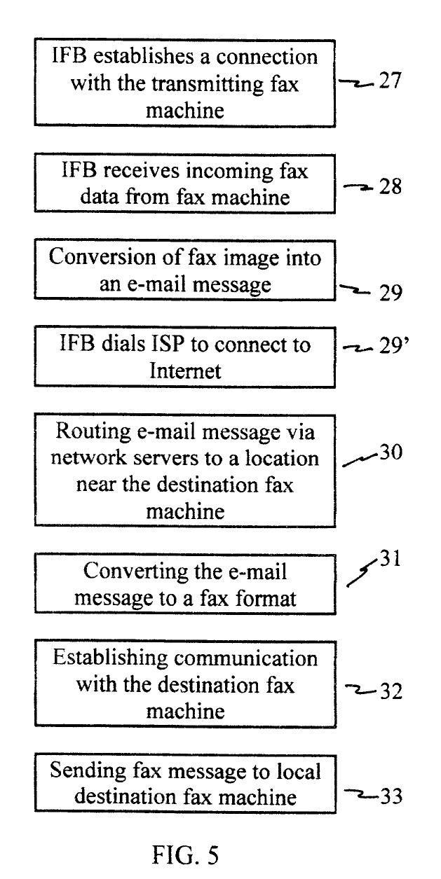

15. FIG. 5 is a flowchart of the steps in the fax transmission process using the IFB.

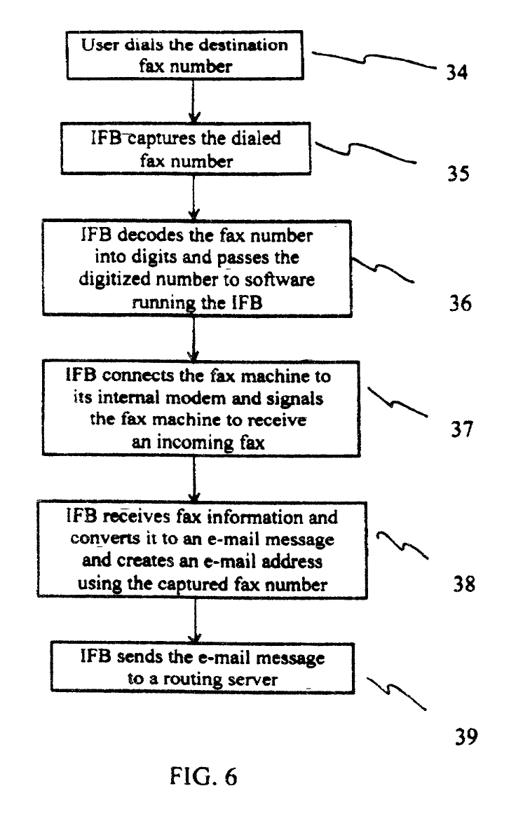

16. FIG. 6 is a flowchart of the internal steps of the IFB during the fax transmission process.

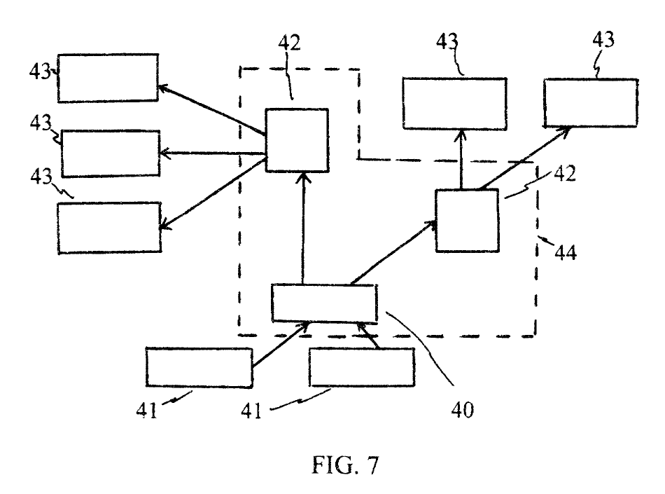

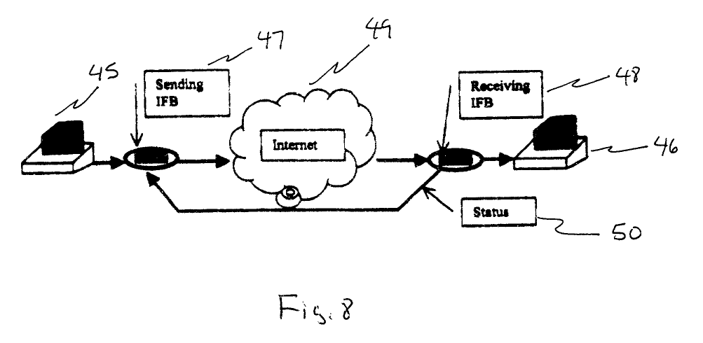

17. FIG. 7 is a configuration of a routing system for a transmitted message via electronic mail.

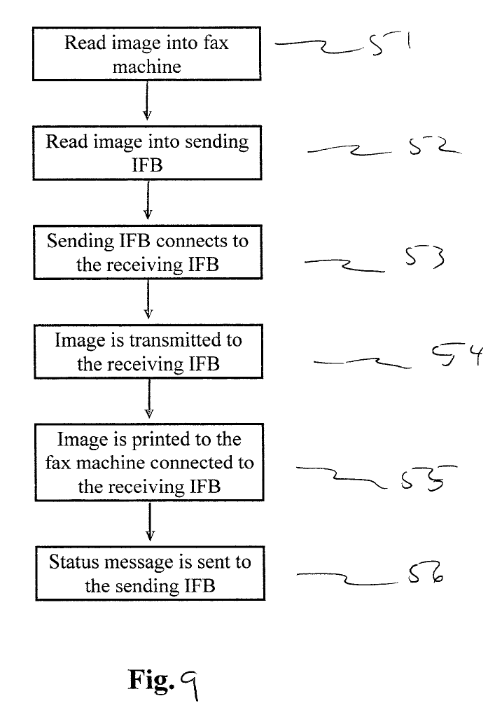

18. FIG. 8 is a configuration of the devices used in the implementation of the present invention.

19. FIG. 9 is a flow diagram of the steps involved in the present invention.

### DETAILED DESCRIPTION OF THE INVENTION

20. This device is a low-cost Internet faxing device referred to hereafter as (“IFB”), that enables one to send and receive fax information using the Internet as the transmission means instead of direct point-to-point telephone communication.

21. The Internet Fax Box, referred to as an IFB, comprises a box containing an input modem for communicating with the facsimile machine and an output modem to communicate with the Internet or other computer network. The IFB supplies the required loop current for communication to the fax machine. This current is necessary in order for the fax modem to operate as if the present invention was also a fax machine. In this arrangement, the fax machine would transmit to and accept information from the present invention.

22. In operation, the user simply dials the destination fax number on their fax machine and the fax is delivered via the IFB and Internet to the destination in any location in the world for the cost of a local telephone call. The present invention receives incoming fax data from a fax machine directly connected to it and converts the fax image into an e-mail message. The e-mail message is routed via on the Internet to a fax server at a location near the destination fax machine by a network of servers. The message is then converted to a fax format and faxed locally to the destination fax machine. This network of servers is in existence today and covers most of the world.

23. Referring to FIG. 1, the IFB 10 connects a facsimile machine (“fax machine”) 11 to the Internet 12. In this configuration, the fax machine sends and receives fax transmissions via the Internet through the IFB. This capability would not be available without the IFB. FIG. 2 shows the exterior of the IFB. The invention does not require any additional external hardware. FIG. 2 shows the front-end configuration of the fax machine connected to the global computer network using an IFB. As shown in FIG. 1, the fax machine 11 connects to the Public Branch Exchange (PBX) 13 through the IFB 10. This PBX is the local telephone company. The PBX connects to the Internet Service Provider (ISP) 14.

24. FIG. 3 is a block diagram of the hardware of the Internet Fax Box. The IFB 10 is basically a diskless low cost embedded PC. It can use a 386 type or above CPU 15 to run conversion, packaging and routing software. A ROM 16 will store all of the software. The RAM 17 will store fax information for transmittal to a destination fax machine or receipt from another fax machine. The software and the OS can be ROMed to reduce costs and power requirements. Two modems 18 and 19 enable the IFB to interface with the fax machine 11 and the Internet 12. The output modem 19 is a standard fax/modem. However, the input modem 18 is a modified fax/modem with a special design. This special modem can consists of an adapter 20 that draws current from the RS-232 line 21 (COM port) of the IFB and supplies it to the two middle wires of the 4-wire RJ11 cable. FIG. 4 shows the basic concept and configuration of this adapter. The adapter 23 is connected to the fax machine 11 by cable 22 and connected to the IFB 10 by cable 20. This connection can be either inside the IFB or external to the IFB. The purpose of this adapter configuration is to simulate the line voltage supplied by the telephone company, when the fax machine is connected to the RJ11 outlet (although the adapter 23 in this embodiment drawings the current from the current source, this function can be performed by other means and without an adapter). Because fax machines communicate on lines with a standard voltage, without these voltages, the fax machine would not be able to send and receive faxes to the modem in the IFB, as well as accept DTMF commands from the IFB. The polarity of the supplied current is not important, as long as the voltage is above 3.5V DC. The RS-232 supplies a clean 3V-5V at pins 4 and 5 of a 9-pins RS-232. The Internet Fax Box has been first implemented in a PC and passed all functional tests. Later, after all the functionality has been verified, the hardware will be optimized for cost by removing all the unnecessary parts and placing it in a small box. Soft modems from PCTel could be integrated into the new design

25. FIG. 5 shows the operation of transmitting fax information using the system of the present invention. At the initiation of a faxing procedure, communication is established 27 between the IFB and the transmitting fax machine. The IFB then receives the incoming fax data from a fax machine directly connected to it 28 and converts the fax image into an e-mail message 29. The IFB then dials the Internet Service Provider (ISP) 29′ to connect to the Internet. The e-mail message is routed to a location near the destination fax machine by a network of servers 30. The message is then converted to a fax format and faxed locally to the destination fax machine 31. This network of servers is in existence today and covers most of the world. One of the routing networks needed for routing the faxes is created and maintained by the Outreach group and their Remote Printing project. For more information see: http://www.faxtel.com. There are also a number of other private networks that perform similar functions. The local fax server then establishes communication with the destination fax machine 32. After establishing successful communication with the destination fax machine, the local server transmits the fax information to the destination fax machine 33. If there is no successful connection with the destination fax machine, the entire transmission fails, as is the case with current fax transmissions. The sender is informed by receiving e-mail message, which can be initiated to the IFB.

26. The procedure described in FIG. 5, gives an overview of worldwide toll free faxing in accordance with the present invention. The description of the operations of the IFB involves steps 27, 28, 29 and 29′. The steps of the IFB operations are described and shown in FIG. 6. The user prepares to send the fax on their fax machine by dialing the destination fax number 34. The number is captured 35 in the Internet Fax Box by a DTMF-receiver (Dual Tone Multi-Frequency receiver) chip on a special hardware board. This chip could also be on the CPU board. The DTMF-receiver decodes dial tones generated by telephone and fax dialers into digits 36. The digitized dialed number is then passed to the software running in the IFB.

27. When the user presses the START/SEND button on the fax machine, the IFB connects the fax machine to its internal fax/modem card and signals the fax machine that it is ready to receive the incoming fax 37. Because of the adapter configuration 20 and 21 of FIG. 4, the fax machine cannot distinguish between the local and remote fax, and “thinks” that a remote fax machine has responded and precedes to send the fax.

28. The Fax/Modem card 21 receives the fax from the local fax machine and passes 38 it to the executing software in the IFB. This software converts it to TIFF class F format and packages it as a MIME e-mail message. Note that the fax can be sent in graphics form. The software also creates the e-mail address using the telephone number that was captured from the fax machine. For example, the e-mail address might look like this:

29. Remote-printer.ivo.zinkov/FaxTel Inc. @12816461310.iddd.tpc.int.

30. The numbers “12816461310” represent the destination fax number. From this number, a determination is made as to the location of the destination-receiving device. It is necessary to package this number in an e-mail address in order to transmit over the Internet. With conventional telephone lines, the communication between fax machines is one-to-one. The message is routed directly over the telephone lines to the destination number. The Internet is not a direct one-to-one system. In order to transmit over the Internet, the number has to be carried in an e-mail address. The IFB then sends 39 the e-mail message to the Routing Server as shown in FIG. 7. The fax is then routed to the appropriate Cell server and from there is faxed locally to the destination fax. The Cell Server converts the e-mail address back to the original telephone format. The routing network needed for routing the faxes is currently created and maintained in the TPC.INT domain. There are also several other private networks that perform similar functions.

31. As shown in FIG. 7, the routing network included a routing server 40 that routes e-mail messages from a sending IFB 41 to a local fax server 42 and ultimately to the destination fax machines 43. The routing server 40 and the fax servers 42 are within the Internet 44. During an e-mail routing sequence, the e-mail message from the IFB is first sent to a ROUTING SERVER 40, which is responsible for routing the messages to the appropriate destination based on the telephone number and area code of the destination fax number. This number is embedded in the e-mail address generated by the IFB. The routing server in turn sends the message to one of the CELL FAX servers 42 around the world. The Cell Fax server converts the message back into the fax format and faxes it to the local fax machine. The telephone number is encoded into the e-mail address. The IFB will intercept the outgoing fax call, extract the dialed number and will place it in the e-mail address.

32. The software consists of embedded OS, email system and some software to convert between fax format and MINE/TIFF format for sending as e-mail messages. The main IFB software is designed for easy upgrades and changes, utilizing object-oriented techniques. It is designed in modular fashion, with well-defined interface between its components. If, for example, an applicant decides to move to real-time faxing in the future, only one component needs to be replaced, namely the fax sender component.

33. Protocol—SMPT (mail) protocol is used, because it is a standard protocol for Internet faxing. The faxes, packaged as mail messages, can be received by Windows-based PC, and displayed in standard TIFF viewers.

34. MIME and TIFF formats—these are standard formats used for sending and receiving mail and fax messages over the Internet.

35. The Internet Fax Box has the following unique features and advantages:

36. The IFB can send messages over “standard” Internet network of servers. This product, in addition to allowing people to send faxes over the Internet, also make use of the largest free Internet Fax network in the world. The faxes are routed over the Internet by the network and delivered to the destination fax machine by a local cell from the closest node of this network.

37. The present invention is implemented through a device such as the previously described Internet Fax Box. This invention describes method for sending faxes over the Internet, in which the sender gets a confirmation immediately after sending the facsimile message over a regular, uncontrolled Internet connection, and using standard modems or a Local Area Network (LAN) connection to the Internet. FIG. 8 shows a configuration fax sending a fax message with the IFB device for use in the present invention. In this configuration, sending 45 and receiving fax machines 46 are connected to each other via sending 47 and receiving 48 IFB's. The IFB's are connected to each other and thereby connect the two-fax machines via the Internet 49. A status response 50 occurs between the two IFB's in this configuration.

38. In operation the present invention works in conjunction with the Internet Facsimile Box (IFB) described in U.S. patent application Ser. No. 09/289,756. The steps to this operation are as follows: 1) The image is initially read into a fax machine in the conventional manner 51; 2) The fax image is read into the sending IFB 52. The sending facsimile machine disconnects from the sending IFB; 3) the sending IFB connects to the receiving IFB 53 by contacting its fully qualified host name; 4) The facsimile image is transmitted to the receiving IFB 54; 5) The image is printed to the fax machine connected to the remote IFB 55; 6) A status message is sent to the sending IFB 56, which is displayed on the LCD of the sending IFB. The sender is aware of the status of the sent facsimile message at that time. The method of the present invention eliminates the stringent real-time requirements imposed by timing constraints of regular fax machines. The method allows the sender to get immediate acknowledge from the receiving fax machine, without the extra expenses of a true real-time faxing operation.

39. The methods of this invention provide significant advantages over the current art. The invention has been described in connection with its preferred embodiments. However, it is not limited thereto. Changes, variations and modifications to the basic design may be made without departing from the inventive concepts in this invention. In addition, these changes, variations and modifications would be obvious to those skilled in the art having the benefit of the foregoing teachings. All such changes, variations and modifications are intended to be within the scope of this invention, which is limited only by the following claims.

We claim:

1. A computer network access system for establishing access for multiple devices simultaneously and from one access point comprising:
a. at least two devices capable of sending, receiving or accessing data;
b. a computer access device (GCNAD) connected to said remote data devices, said GCNAD capable of connecting said data devices to the computer network, the computer network accessing software for establishing the connection between the GCNAD and the computer network; and computer network accessing software for establishing the connection between the GCNAD and the data devices.

2. The system of claim 1 wherein said GCNAD comprises:
a first input modem for connecting said GCNAD with a said remote data device;
an output modem for connecting to and establishing communication with the computer network; and
a central processing unit for executing said accessing software.

3. The system of claim 2 wherein said accessing software for establishing the connection between the GCNAD the global computer network comprises a dip utility program to dial out through said output modem to connect to an Internet Service Provider.

4. The system of claim 1 wherein said remote data devices comprise a personal computer and a facsimile machine.

5. The system of claim 4 wherein said accessing software in said GCNAD comprises a dip login server program to enable a remote personal computer device to dial-up the GCNAD and establish communication with the GCNAD.

6. The system of claim 2 wherein said GCNAD further comprises a second input modem for providing communication with a said remote data device.
